(19) United States
(12) Patent Application Publication
(10) Pub. No.: US 2025/0115819 A1
(43) Pub. Date: Apr. 10, 2025

(54) Cannabinoid Infused Biodegradable Briquettes and Fire Logs

(71) Applicant: Shree Browne, Victorville, CA (US)

(72) Inventor: Shree Browne, Victorville, CA (US)

(21) Appl. No.: 18/908,039

(22) Filed: Oct. 7, 2024

Related U.S. Application Data
(60) Provisional application No. 63/542,804, filed on Oct. 6, 2023.

(51) Int. Cl. C10L 5/44

(52) U.S. Cl. CPC C10L 5/44; C10L 2200/0469; C10L 2200/0484; C10L 2230/08

(57) ABSTRACT

The Cannabinoid Infused Biodegradable Briquette and Fire Log is the only product of its kind that uses modern compressed combustible fibers with cannabinoids to aid in the reduction of stress and anxiety or as a flavor additive. This device is light and easily transported for use anywhere a fire can be used. The biodegradable structure allows for it to naturally decompose in a way that is not harmful to the environment after use.

### CROSS REFERENCE

The present non-provisional patent application claims priority to the Provisional patent application U.S. 63/542,804 filed Oct. 6, 2023 by Shree Browne included by reference in its entirety.

### BACKGROUND

Combustible briquette and fire logs use smoke to add flavor to the food you are cooking. Various scents, and even flavors are added to the fire logs to enhance food and ambiance.

A firelog is a manufactured log constructed to be used as wood fuel. Firelogs are designed to be inexpensive, while being easier to ignite, and burn longer, and more efficiently than firewood. Firelogs are traditionally manufactured using two methods: the first uses only compressed sawdust and the second uses sawdust and paraffin, which is mixed and extruded into a log shape. The extruded firelogs are individually wrapped in paper packaging which can be ignited to start burning the firelog as the paraffin is readily combustible.

### SUMMARY OF THE DISCLOSURE

A fire log is a manufactured log constructed to be used as fuel in a combustible setting. Fire logs are pretreated to burn more efficiently than traditional firewood. Cannabinoid logs would aid in the reduction of anxiety and stress via smoke inhalation. A briquette is a block of compressed combustible materials including cannabinoid and natural oils and blends, sawdust, rice hull and by-products used for fuel generally in cooking.

A disclosed briquette and fire log includes an infusion of a primary material of the briquette/fire log with a secondary material. A flat surface on the briquette/fire log is defined on a major surface of a geometry of the briquette/fire log and an array of holes defined on the flat surface through the briquette parallel with a plane of the flat surface.

### BRIEF DESCRIPTION OF THE DRAWINGS

FIG. 1 is a front perspective view of cannabinoid infused cylindrical briquette fire log in accordance with an embodiment of the present disclosure.

FIG. 2 is a front perspective view of a cannabinoid infused rectilinear briquette fire log in accordance with an embodiment of the present disclosure.

FIG. 3 is a front perspective view of a cannabinoid infused spherical briquette fire log in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

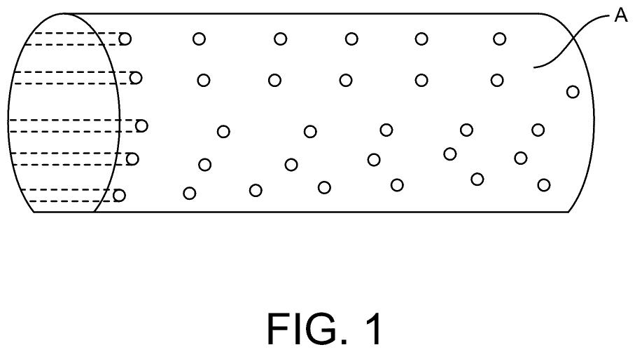

FIG. 1 is a Front perspective view of the Cannabinoid infused cylindrical biodegradable briquette fire log referenced as A, in accordance with an embodiment of the present disclosure.

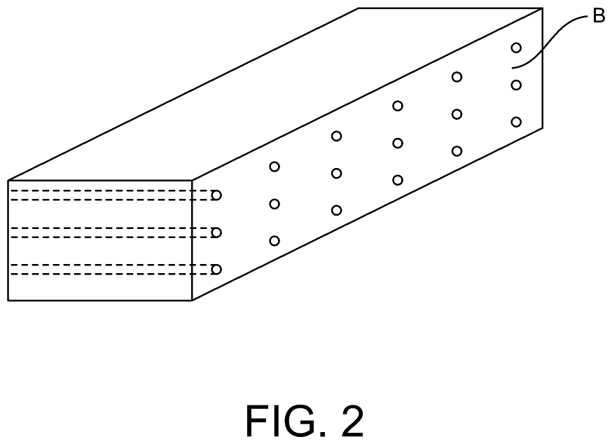

FIG. 2 is a front perspective view of the cannabinoid infused rectilinear biodegradable briquette fire log referenced as B, in accordance with an embodiment of the present disclosure.

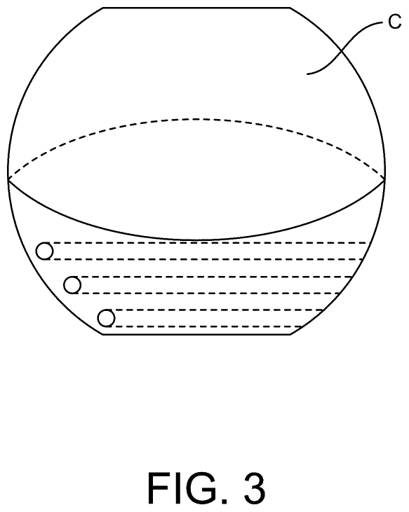

FIG. 3 is a front perspective view of the cannabinoid infused spherical biodegradable briquette fire log referenced as C in accordance with an embodiment of the present disclosure.

The present disclosed fire log, also known as “Cannabinoid Infused Biodegradable Briquettes and Fire Logs.” Offers a way to use the medicinal effects of cannabinoids if a wider setting. Traditional methods of using cannabis or the like are not able to use in a wide setting. Most individuals use devices that require individual inhalation or consumption of cannabis or the like. The fore mentioned fire log and briquette not only allow for a wider dispersal of the smoke but can be consumed on your choice of cookable food. Studies have shown that at lower doses some cannabinoids can reduce symptoms of stress and anxiety disorders.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A briquette comprising: an infusion of a primary material of the briquette with a secondary material; a flat surface on the briquette defined on a major surface of a geometry of the briquette; and an array of holes defined on the flat surface through the briquette parallel with a plane of the flat surface.

2. The briquette of claim 1, wherein the secondary material is an aromatic material comprising marijuana.

3. The briquette of claim 1, wherein the primary material is a biodegradable material.

4. The briquette of claim 1, further comprising a fire retardant coating of the array of holes configured to delay a burning of the briquette to a smolder.

5. The briquette of claim 1, further comprising a fire retardant in the briquette configured to delay a burning of the briquette to a smolder.

6. The briquette of claim 1, wherein a burning of the briquette occurs from a sidestream of hot gas through the array of holes.

7. The briquette of claim 1, wherein the flat surface of the briquette is defined on a portion of a circumference of a cylinder.

8. The briquette of claim 1, wherein the flat surface of the briquette is a larger side of a parallelogram compared to a smaller side thereof.

9. The briquette of claim 1, wherein the flat surface of the briquette is defined on a surface of a spherical pellet.

10. The briquette of claim 1, wherein the array of holes extend through the flat surface of the briquette to another surface of the briquette.

11. The briquette of claim 1, where an ingress of a sidestream of smoldering smoke on the flat surface terminates at an egress of the sidestream through the briquette.

12. The briquette of claim 1, wherein the briquette is one of a plurality of briquette pellets for a smoking of an edible food.

13. The briquette of claim 12, wherein the briquette pellets are infused through a tincture with a cannabis tincture.

14. The briquette of claim 1, wherein the briquette is a fire log.

15. The briquette of claim 13, further comprising a plurality of fire logs wherein the flat surface is defined orthogonally to a stacking of the fire logs.

16. The briquette of claim 1, wherein the primary material includes a block of compressed combustible materials including sawdust, rice hull and by-products and the secondary material includes natural oils and oil blends including cannabinoid oils.
